(19) United States
(12) Patent Application Publication
(10) Pub. No.: US 2025/0080707 A1
(43) Pub. Date: Mar. 6, 2025

(54) VIDEO PROCESSING DEVICE AND VIDEO PROCESSING SYSTEM

(71) Applicant: LAPIS Technology Co., Ltd., Yokohama (JP)

(72) Inventor: Takuya MOTOHASHI, Yokohama (JP)

(73) Assignee: LAPIS Technology Co., Ltd., Yokohama (JP)

(21) Appl. No.: 18/814,376

(22) Filed: Aug. 23, 2024

(30) Foreign Application Priority Data
Aug. 31, 2023 (JP) 2023-140898

(51) Int. Cl. H04N 9/76; B60R 1/26

(52) U.S. Cl. CPC H04N 9/76; B60R 1/26; B60R 2300/303

(57) ABSTRACT

It is an object to provide a video processing device and a video processing system capable of synthesizing a plurality of videos and displaying the synthesized video on a single screen in a form according to a request of a user. The disclosure includes a synthesis processing unit that generates a synthetic video signal by rendering a first video included in a designated region in a screen transparent and synthesizing the first video and a second video in a manner in which the first video based on a first video signal is arranged in the screen and the second video based on a second video signal different from the first video signal is arranged in the screen, and a memory that stores transparency control data for specifying the designated region and indicating a transparency aspect of the first video in the designated region.

### CROSS-REFERENCE TO RELATED APPLICATION

This application is based upon and claims the benefit of priority from the prior Japanese Patent Application No. 2023-140898 filed on Aug. 31, 2023, the entire contents of which are incorporated herein by reference.

### BACKGROUND

### 1. Technical Field

The disclosure relates to a video processing device that synthesizes a plurality of video signals and a video processing system including the video processing device.

### 2. Description of the Related Art

Currently, as an electronic device for supporting driving of a vehicle, a video processing system in which a front side, a rear side, right and left sides, and the like of a vehicle are recorded using a plurality of cameras, and the videos taken by the respective cameras are synthesized and indicated on a display installed at a dashboard and a rearview mirror is productized.

As such a video processing system, there has been provided a display control device that records a rear side, right rear and left rear, of own vehicle by respective cameras, seamlessly synthesizes the taken videos, and displays a rear view in a wide range on a rearview mirror (see FIG. 26, FIG. 27, and the like of WO 2019/111307). In this the display control device, a part having a low degree of importance for driving operation is detected in the synthetic video, and the part is “blurred” to increase visibility of a part having a high degree of importance.

As the video processing system described above, there has been proposed a blind spot image display device that records blind spot areas at respective left side and right side in front of a vehicle by two cameras provided at respective left and right corner portions of a front bumper of the vehicle, and displays one on a right half and the other on a left half of a screen of an in-vehicle monitor (see, for example, JP-A-2003-127772). With such a blind spot image display device, a driver can confirm views of the blind spots at mutually different two positions (right side and left side of the front of the vehicle) by viewing the screen of the in-vehicle monitor.

Now, since the two recorded videos described in JP-A-2003-127772 are each recorded at the same time point from the own vehicle, the two recorded videos have similar pictures, brightnesses, and color tones in some cases. Therefore, as described in the blind spot image display device of JP-A-2003-127772, when mutually discontinuous two recorded videos are linked to be displayed in one screen, a boundary between the respective recorded videos becomes unclear.

Additionally, when a plurality of recorded videos for driving assistance are linked to be displayed in one screen, it is desired to configure the display size of each recorded video to be changeable.

Therefore, it is an object of the disclosure to provide a video processing device and a video processing system capable of synthesizing a plurality of videos and displaying the synthesized video in a single screen in a form according to a request of a user.

### SUMMARY

A video processing device according to the disclosure includes a synthesis processing unit and a memory. The synthesis processing unit generates a synthetic video signal by rendering a first video included in a designated region in a screen transparent and synthesizing the first video and a second video in a manner in which the first video based on a first video signal is arranged in the screen and the second video based on a second video signal different from the first video signal is arranged in the screen. The memory stores transparency control data for specifying the designated region and indicating a transparency aspect of the first video in the designated region.

A video processing system according to the disclosure includes a first camera, a second camera, a display device with a single screen, a synthesis processing unit, a memory, and a data change control unit. The first camera outputs a first video signal indicating a recorded video. The second camera outputs a second video signal indicating a recorded video. The synthesis processing unit generates a synthetic video signal by rendering a first video included in a designated region in the screen transparent and synthesizing the first video and a second video in a manner in which the first video based on the first video signal is arranged in the screen and the second video based on the second video signal different from the first video signal is arranged in the screen. The memory stores transparency control data for specifying the designated region and indicating a transparency aspect of the first video in the designated region. The data change control unit overwrites the transparency control data stored in the memory with transparency control data for rewrite when the data change control unit receives the transparency control data for rewrite and a data change command.

### BRIEF DESCRIPTION OF THE DRAWINGS

Features of the disclosure will be described below with reference to the accompanying drawings.

FIG. 1 is a block diagram illustrating a configuration of a video processing system 100 as a first embodiment of a video processing system according to the disclosure;

FIG. 2 is a diagram illustrating exemplary installation positions of cameras 10a and 10b, and a display device 30 in a vehicle;

FIG. 3A is a diagram illustrating an exemplary form of a screen of the display device 30;

FIG. 3B is a diagram illustrating an exemplary form of a video region fa taken from a video Fa indicated by a recorded video signal Va;

FIG. 3C is a diagram illustrating an exemplary form of a video region fb taken from a video Fb indicated by a recorded video signal Vb;

FIG. 4 is a diagram illustrating an exemplary data format of transparency control data TD;

FIG. 5 is a diagram illustrating an aspect of synthesis of videos GA and GB by a synthesis processing unit 23;

FIG. 6 is a diagram illustrating a display form of the videos GA and GB synthesized to be displayed on the screen of the display device 30 based on the transparency control data TD illustrated in FIG. 4;

FIG. 7 is a diagram illustrating an exemplary data format of the transparency control data TD;

FIG. 8 is a diagram illustrating a display form of the videos GA and GB synthesized to be displayed on the screen of the display device 30 based on the transparency control data TD illustrated in FIG. 7;

FIG. 9A is a diagram illustrating an example of another display form of the videos GA and GB synthesized to be displayed on the screen of the display device 30;

FIG. 9B is a diagram illustrating an example of still another display form of the videos GA and GB synthesized to be displayed on the screen of the display device 30;

FIG. 10 is a block diagram illustrating a configuration of a video processing system 100A as a second embodiment of the video processing system according to the disclosure;

FIG. 11A is a diagram illustrating exemplary transparency control data OSD;

FIG. 11B is a diagram illustrating an exemplary video signal VTd in which a “00h” region indicating black is added to a video signal VTb indicating the video GB as a transparency region;

FIG. 11C is a diagram illustrating a display video in which the video GB indicated by the video signal VTd is coupled with the video GA indicated by a video signal VTa;

FIG. 12 is a diagram illustrating an example of a configuration of a substrate module that achieves a video processing device 20 (20A);

FIG. 13 is a diagram illustrating another example of the configuration of the substrate module that achieves the video processing device 20 (20A); and

FIG. 14 is a diagram illustrating a modification of the configuration of the substrate module illustrated in FIG. 13.

### DETAILED DESCRIPTION

In the disclosure, to display the first video based on the first video signal in the screen and display the second video based on the second video signal arranged in the designated region of the screen, a synthesis signal in which the first and the second videos are synthesized is generated as follows. That is, the transparency control data for specifying the designated region and indicating the transparency aspect of the first video in the designated region is stored in the memory, and by rendering the first video included in the designated region of the screen transparent and synthesizing the first video and the second video according to the transparency control data read from the memory, the synthetic video signal is generated.

With this configuration, by changing the content of the transparency control data stored in the memory, the size of the second video displayed in the designated region of the screen in which the first video is displayed and the shape of the boundary between the first and the second videos can be changed to those according to the request of the user.

### Embodiment 1

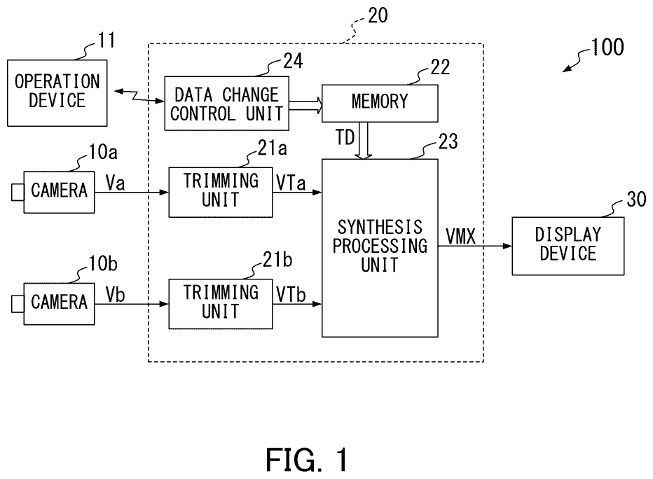

FIG. 1 is a block diagram illustrating a configuration of a video processing system 100 installed in a vehicle as an example of a video processing system according to the disclosure.

The video processing system 100 includes cameras 10a and 10b, a video processing device 20, and a display device 30.

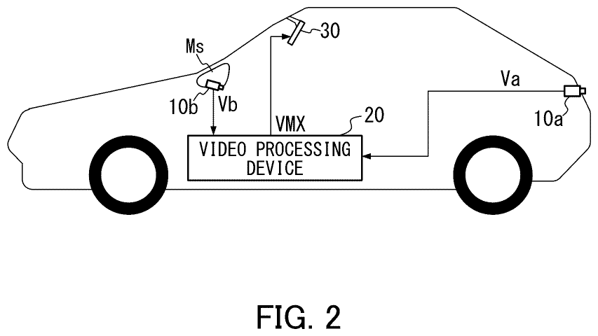

The camera 10a is installed at a rear side of a vehicle, for example, as illustrated in FIG. 2, outputs a recorded video signal Va indicating a video recording the rear of the vehicle, and supplies it to the video processing device 20.

The camera 10b is installed at a left side mirror Ms of the vehicle, for example, as illustrated in FIG. 2, and outputs a recorded video signal Vb indicating a video recording the left rear of the vehicle, and supplies it to the video processing device 20.

An operation device 11 is configured of, for example, a smartphone, and wirelessly transmits transparency control data for rewrite and a data change command that prompts a change to the transparency control data for rewrite, which are generated by a user operation, to the video processing device 20.

The video processing device 20 includes trimming units 21a and 21b, a memory 22, a synthesis processing unit 23, and a data change control unit 24.

The trimming unit 21a cuts out a video region having an aspect ratio and the number of dots equal to an aspect ratio and the number of dots of a screen of the display device 30 from the video of the vehicle rear side indicated by the recorded video signal Va.

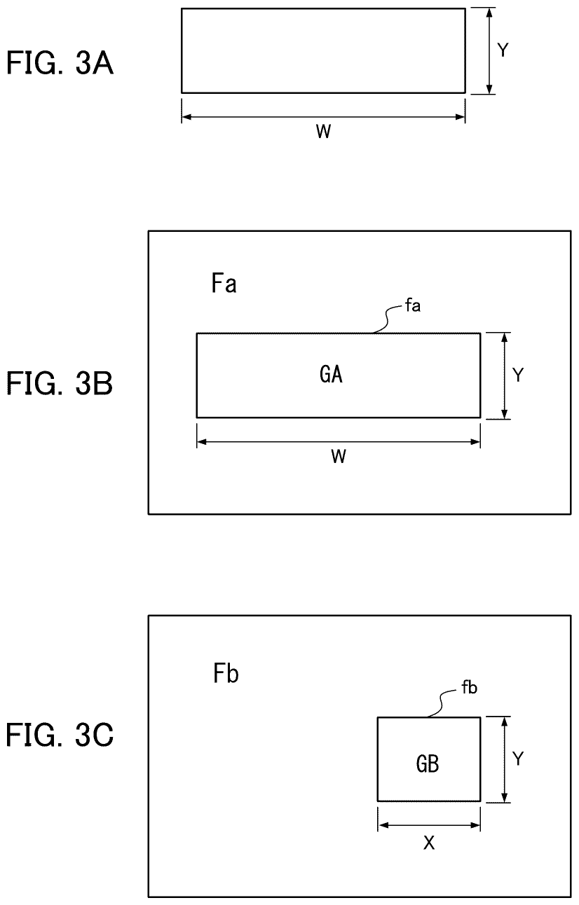

For example, as illustrated in FIG. 3A, when the screen of the display device 30 has a resolution of
Horizontal direction: W (W is an integer) dots
Vertical direction: Y (Y is an integer) dots,
   the trimming unit 21a cuts out a video region fa of the horizontal direction: W dots and the vertical direction: Y dots from a video Fa indicated by the recorded video signal Va as illustrated in FIG. 3B. Then, the trimming unit 21a supplies a video signal in the recorded video signal Va indicating the video GA in the video region fa to the synthesis processing unit 23 as a video signal VTa.

The trimming unit 21b cuts out a video region having a predetermined number of dots in the horizontal direction and the number of dots in the vertical direction equal to the number of dots in the vertical direction of the screen of the display device 30 from the video of the vehicle left rear side indicated by the recorded video signal Vb.

For example, as illustrated in FIG. 3C, the trimming unit 21b cuts out a video region fb of the horizontal direction: X (X is an integer of W or less) dots and the vertical direction: Y dots from a video Fb indicated by the recorded video signal Vb. Then, the trimming unit 21b supplies a video signal in the recorded video signal Vb indicating the video GB in the video region fb to the synthesis processing unit 23 as a video signal VTb.

The memory 22 is a non-volatile semiconductor memory, such as a flash memory, and stores transparency control data TD used in transparent composition of the video signal VTa and the video signal VTb.

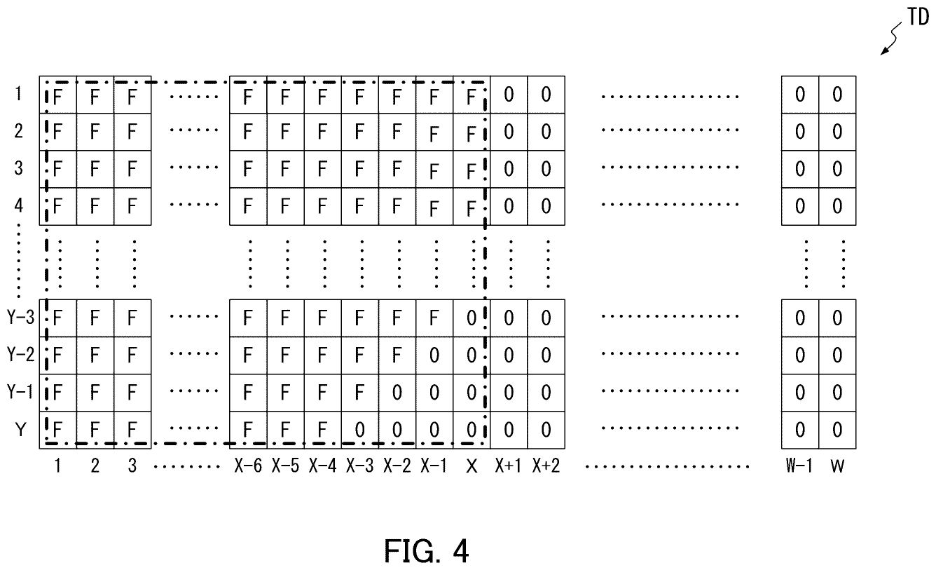

FIG. 4 is a diagram illustrating an exemplary format of the transparency control data TD.

The transparency control data TD is configured of (W×Y) dot data pieces indicating transmittance of each of dots of the screen (first row to Y-th row×first column to W-th column) of the display device 30 illustrated in FIG. 3A. Each of the dot data pieces indicates the transmittance of the video signal VTa in the transparent composition of the video signals VTa and VTb, and the transmittance is expressed in 4 bits (hexadecimal notation) in the example illustrated in FIG. 4. For example, when the dot data piece indicates “F,” the transmittance is 100%, when the dot data piece indicates “8,” the transmittance is 50%, and when the dot data piece indicates “0,” the transmittance is 0%. At the factory shipment, as the transparency control data recommended by the supplier, for example, the initial transparency control data TD with the content as illustrated in FIG. 4 is stored.

The memory 22 reads the above-described transparency control data TD in response to turning on of the power, and supplies it to the synthesis processing unit 23.

The data change control unit 24 receives the transparency control data for rewrite and the data change command wirelessly transmitted from the operation device 11, and performs a write access to the memory 22 to overwrite the content of the transparency control data stored in the memory 22 with the received transparency control data for rewrite, thereby updating the transparency control data.

The synthesis processing unit 23 generates a synthetic video signal VMX by synthesizing the video signal VTa and the video signal VTb in a form in which the video signal VTa is rendered transparent with the transmittance based on the transparency control data TD.

For example, in a region in which the dot data pieces in the transparency control data TD indicate “F,” since the transmittance of the video signal VTa is 100%, the synthesis processing unit 23 uses the video signal VTb directly as the synthetic video signal VMX. In a region in which the dot data pieces indicate “8,” since the transmittance of the video signal VTa is 50%, the synthesis processing unit 23 synthesizes the video signal VTa with the video signal VTb in a form in which the transmittance of the video signal VTa is 50%, and uses it as the synthetic video signal VMX. In a region in which the dot data pieces indicate “0,” since the transmittance of the video signal VTa is 0%, that is, non-transmitting, the synthesis processing unit 23 uses the video signal VTa directly as the synthetic video signal VMX.

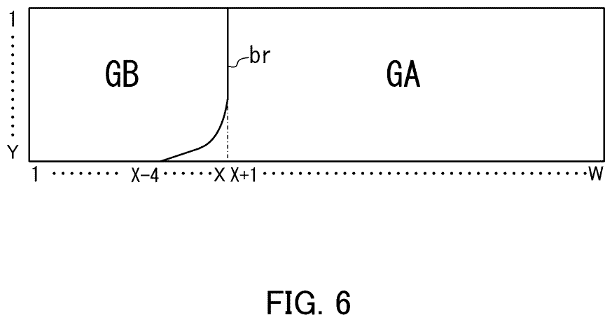

The display device 30 is, for example, an electronic inside rearview mirror mounted in a room of the vehicle as illustrated in FIG. 2, and includes a two-dimensional screen having a horizontally long shape as illustrated in FIG. 3A similar to the electronic inside rearview mirror. The display device 30 displays the video GA of the vehicle rear side recorded by the camera 10a on the screen of the display device 30 itself based on the synthetic video signal VMX as illustrated in FIG. 6, and displays the video GB of the vehicle left rear side recorded by the camera 10b in a designated region designated at a left end in the screen.

Incidentally, in the video processing device 20, a size of the video GB displayed in the screen of the display device 30 and a shape of a boundary between the videos GA and GB can be set depending on the content of the transparency control data TD.

For example, in the transparency control data TD illustrated in FIG. 4, each of the dot data pieces in a region of the first row to the Y-th row×the (X+1)-th column to the W-th column in which the video GA is displayed in the screen of the display device 30 indicates “0” representing the transmittance of 0%. Further, in the transparency control data TD illustrated in FIG. 4, each of the dot data pieces in a region in which the video GB is synthesized (region enclosed by one-dot chain line) indicates “F” representing the transmittance of 100% or “0” representing the transmittance of 0%. That is, in the rectangular region enclosed by the one-dot chain line in FIG. 4, each of the dot data pieces included in a region at a right lower corner portion defined by a concave arc-shaped line indicates “0,” and all the dot data pieces included in the other region indicate “F.”

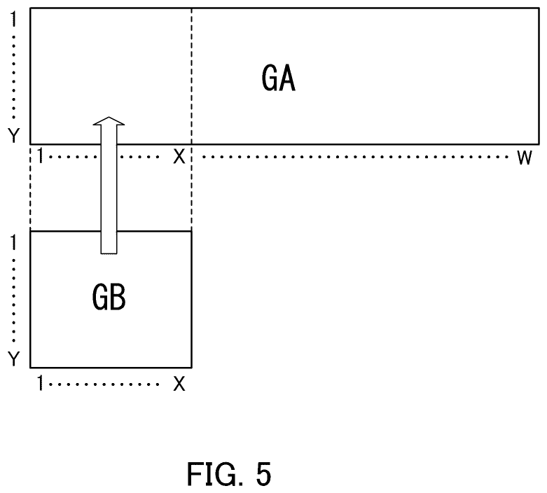

In the transparency control data TD illustrated in FIG. 4, the region in which the video GB is displayed in the screen of the display device 30 (designated region) is designated by the dot data pieces that indicate “F” representing the transmittance of 100%. That is, as illustrated in FIG. 5, the video GB is synthesized in [the first row to the Y-th row]×[the first column to the X-th column], and as illustrated in FIG. 6, the video GB is displayed in the designated region corresponding to a dot data piece group having “F” representing the transmittance of 100%. At this time, a boundary br between the videos GA and GB has a linear shape from an upper end to the proximity of the center of the screen, and a curved shape in a section from the proximity of the center to a lower end of the screen.

Depending on the content of the transparency control data TD, the boundary between the videos GA and GB displayed on the display device 30 can be configured in a strip shape with a width.

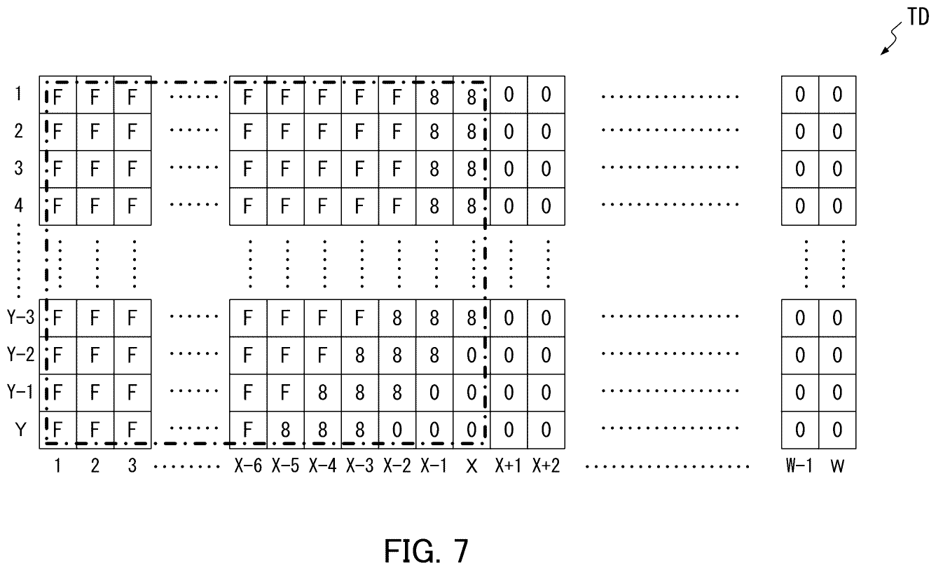

FIG. 7 is a diagram illustrating another example of the format of the transparency control data TD in consideration of the above-described point.

In the transparency control data TD illustrated in FIG. 7, in a region in which the video GB is synthesized (region enclosed by one-dot chain line), values of the dot data pieces in a plurality of columns adjacent to each of the dot data pieces indicating “0” representing the transmittance of 0% are “8” representing the transmittance of 50%, and values of the other dot data pieces are the same as those of the transparency control data TD illustrated in FIG. 4.

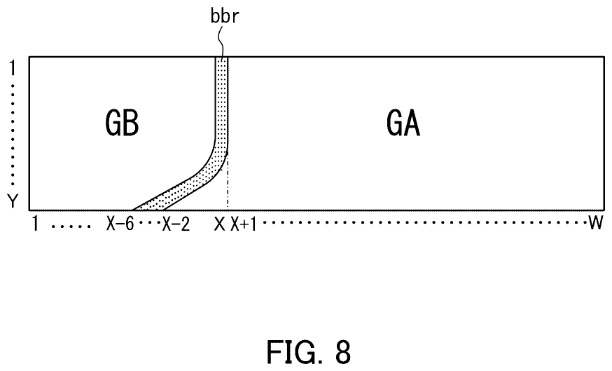

Therefore, according to the transparency control data TD illustrated in FIG. 7, a strip-shaped boundary bbr having a width corresponding to the number of the dot data pieces indicating “8” representing the transmittance of 50% adjacent in the horizontal direction is displayed in the screen of the display device 30 as the boundary between the videos GA and GB as illustrated in FIG. 8.

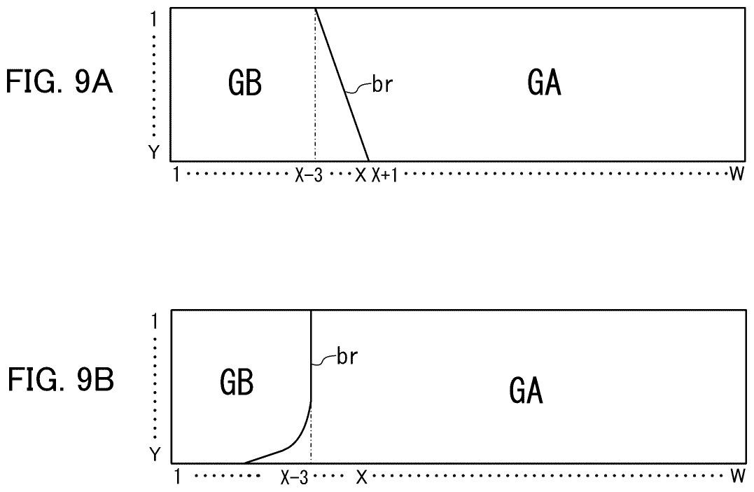

Thus, depending on the content of the transparency control data TD, the boundary br between the videos GA and GB can be displayed in a linear shape for example, as illustrated in FIG. 9A. Alternatively, as illustrated in FIG. 9B, the display size of the video GB can be changed to the first row to the Y-th row×the first column to the (X−3)-th column narrower than the region of the first row to the Y-th row×the first column to the X-th column illustrated in FIG. 6.

That is, in the initial state after the factory shipment, for example, the videos GA and GB are displayed in the screen of the display device 30 in the form as illustrated in FIG. 6 based on the transparency control data TD illustrated in FIG. 4. Then, by the operation of changing the transparency control data TD by the user using the operation device 11, as illustrated in FIG. 8, FIG. 9A, FIG. 9B, or the like, the size in the horizontal direction of the video GB displayed in the screen of the display device 30 and the shape of the boundary between the videos GA and GB can be changed to the configuration that the user desires.

### Embodiment 2

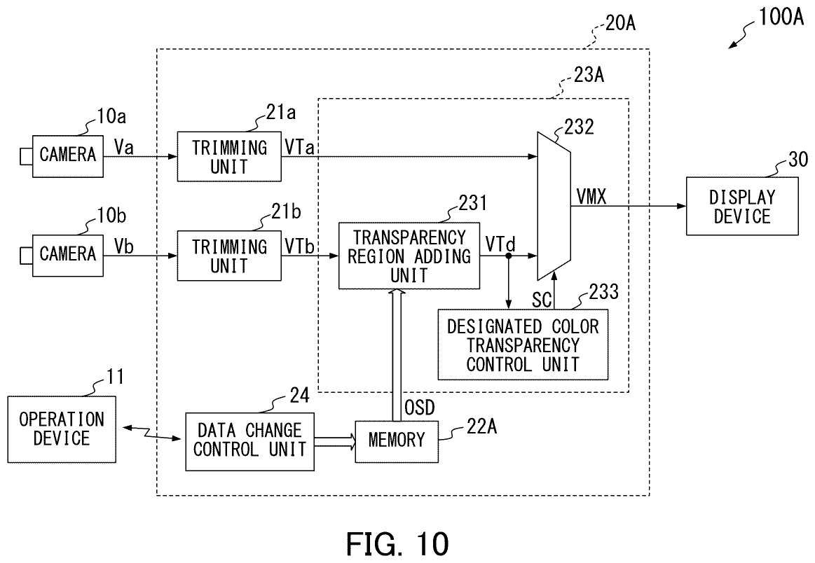

FIG. 10 is a block diagram illustrating a configuration of a video processing system 100A as another example of the video processing system according to the disclosure.

The video processing system 100A includes cameras 10a, 10b, an operation device 11, and a display device 30 similarly to the video processing system 100 illustrated in FIG. 1, and employs a video processing device 20A instead of the video processing device 20 included in the video processing system 100.

The video processing device 20A includes trimming units 21a, 21b and a data change control unit 24 similarly to the video processing device 20 illustrated in FIG. 1, and employs a memory 22A and a synthesis processing unit 23A instead of the memory 22 and the synthesis processing unit 23.

The memory 22A is a non-volatile semiconductor memory, such as a flash memory, and stores transparency control data used in transparent composition of the video signal VTa and the video signal VTb.

The transparency control data OSD includes dot data pieces in a region in which the video GA based on the video signal VTa is displayed in the screen of the display device 30 as video data indicating a designated color, and dot data pieces in a region in which the video GB based on the video signal VTb is displayed in the screen of the display device 30 as video data indicating a color other than the designated color.

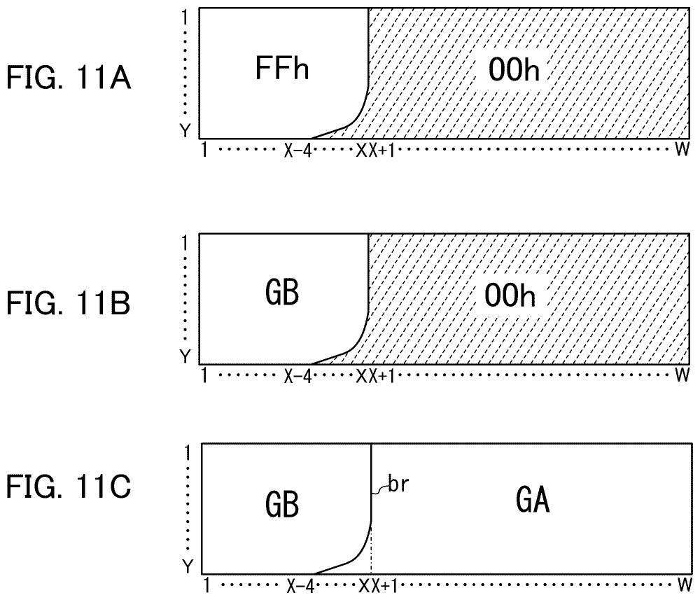

FIG. 11A is a diagram illustrating an exemplary format of the transparency control data OSD.

In the example illustrated in FIG. 11A, the dot data pieces are each expressed in 8 bits (HEX notation). That is, the transparency control data OSD illustrated in FIG. 11A indicates the dot data pieces in the region in which the video GA is displayed in the screen (the first row to the Y-th row×the first column to the W-th column) of the display device 30 as “00h” representing black, and the dot data pieces in the region in which the video GB is displayed (designated region) as “FFh” representing white.

The memory 22A reads the above-described transparency control data in response to turning on of the power, and supplies it to the synthesis processing unit 23A as the transparency control data OSD.

The synthesis processing unit 23A includes a transparency region adding unit 231, a selector 232, and a designated color transparency control unit 233.

The transparency region adding unit 231 receives the above-described transparency control data OSD and the video signal VTb supplied from the trimming unit 21b. The transparency region adding unit 231 replaces the dot data pieces included in the region of “FFh” indicating white in the transparency control data OSD with the video signal VTb indicating the video GB, thereby generating a video signal VTd in which the “00h” region indicating black is added to the video signal VTb indicating the video GB as the transparency region as illustrated in FIG. 11B. Then, the transparency region adding unit 231 supplies the generated video signal VTd to the selector 232 and the designated color transparency control unit 233.

The designated color transparency control unit 233 sequentially receives a series of dot data pieces of the video signal VTd. Then, the designated color transparency control unit 233 generates a selection signal SC to select the video signal VTa when the dot data piece corresponds to “00h” indicating the designated color (black) as illustrated in FIG. 11B and select the video signal VTd when the dot data piece corresponds to “FFh” indicating white, and supplies the selection signal SC to the selector 232. That is, the designated color transparency control unit 233 receives the video signal VTd in which the transparency region has been added, and causes the video signal VTa to be selected in a section indicating the designated color in the video signal VTd. On the other hand, the designated color transparency control unit 233 generates the selection signal SC to select the video signal VTd in a section indicating a color (white) other than the designated color in the video signal VTd.

The selector 232 selects the video signal VTd indicating the video GB when each of the dot data pieces of the video signal VTd does not indicate black, and meanwhile, selects the video signal VTa indicating the video GA when each of the dot data pieces of the video signal VTd indicates black corresponding to the selection signal SC. Then, the selector 232 supplies the selected one of the video signals VTa and VTd to the display device 30 as the synthetic video signal VMX.

That is, by such a selection operation, the selector 232 couples the video GB indicated by the video signal VTd with the video GA indicated by the video signal VTa to synthesize them as illustrated in FIG. 11C.

At this time, similarly to the video processing system 100, also in the video processing system 100A, by the operation of changing the transparency control data OSD by the user using the operation device 11, as illustrated in FIG. 8, FIG. 9A, FIG. 9B, or the like, the size of the video GB displayed in the designated region of the screen of the display device 30 and the shape of the boundary between the videos GA and GB can be changed to the configuration that the user desires.

### Embodiment 3

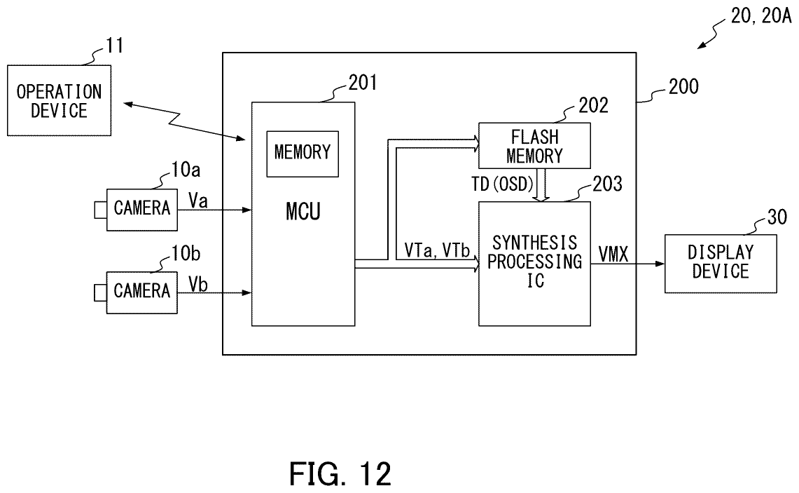

FIG. 12 is a diagram illustrating an example of a configuration of a substrate module that achieves the video processing device 20 (20A).

As illustrated in FIG. 12, the video processing device 20 (20A) is configured of a substrate module in which an MCU (Micro Controller Unit) 201, a flash memory 202 as the memory 22 (22A), and a synthesis processing IC chip 203 as the synthesis processing unit 23 (23A) are mounted on a substrate 200.

The MCU 201 includes a non-volatile memory that stores programs for achieving the write or read control to the flash memory 202 and the operations of the above-described trimming units 21a and 21b and data change control unit 24.

The MCU 201 executes these programs to perform the cutting process as illustrated in FIG. 3B and FIG. 3C on the recorded video signals Va and Vb supplied from the cameras 10a and 10b, respectively, and supply the obtained video signals VTa and VTb to the synthesis processing IC chip 203. Further, the MCU 201 performs a read access to the flash memory 202 to read the transparency control data (TD, OSD) stored in the flash memory 202. At the factory shipment, the transparency control data, for example, as illustrated in FIG. 4 is stored in the flash memory 202.

However, then, the MCU 201 receives the transparency control data for rewrite and the data change command wirelessly transmitted from the operation device 11, and performs a write access to the flash memory 202 to overwrite the content of the transparency control data stored in the flash memory 202 with the received transparency control data for rewrite, thereby updating the transparency control data.

The flash memory 202 reads the transparency control data stored in itself corresponding to the read access from the MCU 201, and supplies it to the synthesis processing IC chip 203 as the transparency control data TD (OSD).

The synthesis processing IC chip 203 includes a circuit to perform the operation of the synthesis processing unit 23 (23A) described above, and supplies the synthetic video signal VMX obtained by synthesizing the video signals VTa and VTb based on the transparency control data TD (OSD) to the display device 30.

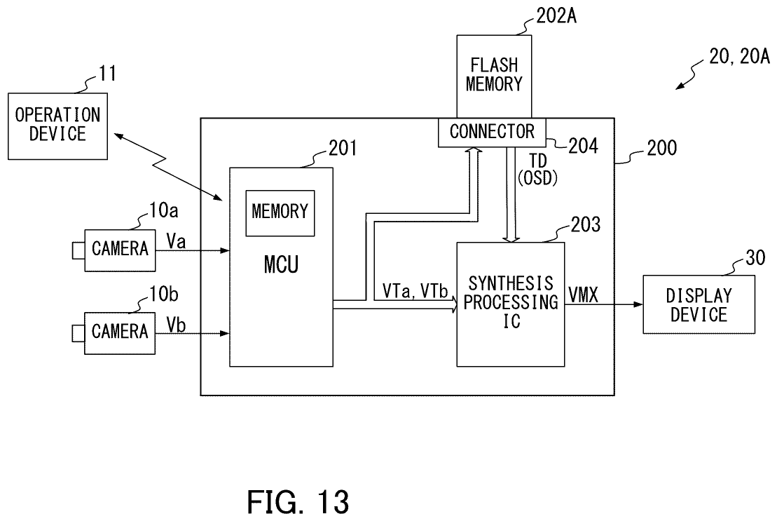

FIG. 13 is a diagram illustrating another example of the configuration of the substrate module that achieves the video processing device 20 (20A).

In the substrate module illustrated in FIG. 13, similarly to the substrate module illustrated in FIG. 12, the MCU 201 and the synthesis processing IC chip 203 are mounted on the substrate 200. However, the flash memory 202 is not mounted, and a connector 204 that removably connects a flash memory is mounted instead of the flash memory 202.

That is, to achieve the video processing device 20 (20A) with the substrate module illustrated in FIG. 13, a flash memory 202A that stores the above-described transparency control data (TD, OSD) is prepared as an external memory, and connected to the connector 204. The flash memory 202A receives the read access from the MCU 201 via the connector 204, reads the transparency control data stored in itself, and supplies the transparency control data to the synthesis processing IC chip 203 via the connector 204 as the transparency control data TD (OSD).

In the substrate module illustrated in FIG. 13, similarly to the substrate module illustrated in FIG. 12, the MCU 201 receives the transparency control data for rewrite and the data change command wirelessly transmitted from the operation device 11, and overwrites the content of the transparency control data stored in the flash memory 202A with the transparency control data for rewrite.

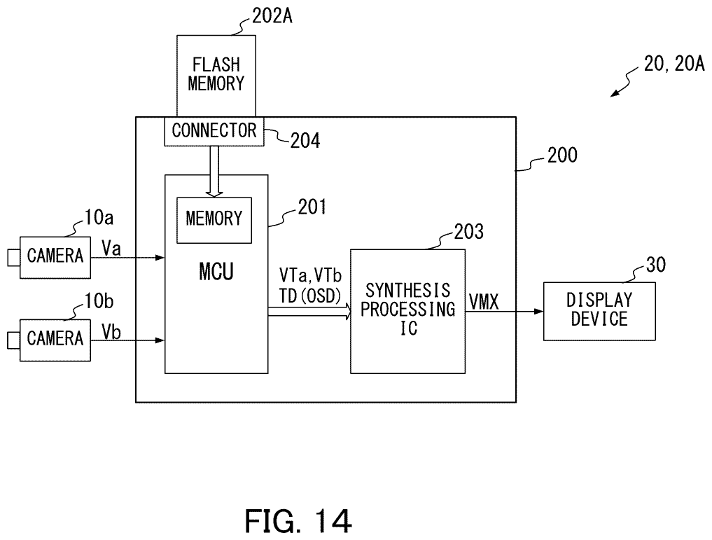

FIG. 14 is a diagram illustrating a modification of the substrate module illustrated in FIG. 13.

In the substrate module illustrated in FIG. 14, a connector 204 that removably connects the flash memory 202A as an external memory is mounted similarly to the substrate module illustrated in FIG. 13. However, in the substrate module illustrated in FIG. 14, when the flash memory 202A is connected to the connector 204, the transparency control data stored in the flash memory 202A is written and stored in the non-volatile memory included in the MCU 201. At this time, the MCU 201 supplies the transparency control data stored in the non-volatile memory included in itself to the synthesis processing IC chip 203 as the transparency control data TD (OSD) together with the video signals VTa and VTb cut out from the recorded video signals Va and Vb as described above.

While the two video signals recorded by the two cameras (10a, 10b) are synthesized to be displayed in the configurations illustrated in FIG. 1, FIG. 10, and FIG. 12 to FIG. 14, it is not necessary that video signals as synthesis targets are recorded by a camera.

Basically, it is only necessary that the video processing device according to the disclosure includes at least the following synthesis processing unit and memory.

That is, the synthesis processing unit (23, 23A) generates the synthetic video signal (VMX) by rendering the first video included in the designated region in the screen transparent and synthesizing the first video and the second video in a manner in which the first video (GA) based on the first video signal (Va, VTa) is arranged in the screen and the second video (GB) based on the second video signal (Vb, VTb) different from the first video signal is arranged in the screen. The memory (22, 22A, 202, 202A) stores the transparency control data (TD, OSD) for specifying the designated region and indicating the transparency aspect (transmittance) of the first video in the designated region.

With this configuration, by changing the content of the transparency control data stored in the memory, the size of the second video (GB) displayed in the designated region of the screen and the shape of the boundary between the first and the second videos can be changed to those according to the request of the user in the screen in which the first video (GA) is displayed.

It is understood that the foregoing description and accompanying drawings set forth the preferred embodiments of the disclosure at the present time. Various modifications, additions and alternative designs will, of course, become apparent to those skilled in the art in light of the foregoing teachings without departing from the spirit and scope of the disclosure. Thus, it should be appreciated that the disclosure is not limited to the disclosed Examples but may be practiced within the full scope of the appended claims.

What is claimed is:

1. A video processing device comprising:
a synthesis processing unit that generates a synthetic video signal by rendering a first video included in a designated region in a screen transparent and synthesizing the first video and a second video in a manner in which the first video based on a first video signal is arranged in the screen and the second video based on a second video signal different from the first video signal is arranged in the screen; and
a memory that stores transparency control data for specifying the designated region and indicating a transparency aspect of the first video in the designated region.

2. The video processing device according to claim 1, wherein
the synthesis processing unit arranges the second video to be superimposed on at least a part of the first video, and the designated region in the screen is in a region in which the first video and the second video are superimposed.

3. The video processing device according to claim 2, comprising
a data change control unit that overwrites the transparency control data stored in the memory with transparency control data for rewrite when the data change control unit receives the transparency control data for rewrite and a data change command.

4. The video processing device according to claim 1, wherein
the transparency control data includes a plurality of dot data pieces corresponding to respective dots in the screen, and
each of the dot data pieces corresponding to respective dots included in the designated region indicates a transmittance of 100%, and each of the dot data pieces corresponding to respective dots included in a region other than the designated region indicates the transmittance of 0%.

5. The video processing device according to claim 1, wherein
the transparency control data includes a plurality of dot data pieces corresponding to respective dots in the screen, and
each of the dot data pieces corresponding to respective dots included in a boundary between the designated region and a region other than the designated region in the screen indicates a transmittance of 50%, each of the dot data pieces corresponding to respective dots excluding the dots included in the boundary among the dots included in the designated region indicates the transmittance of 100%, and each of the dot data pieces corresponding to respective dots included in the region other than the designated region indicates the transmittance of 0%.

6. The video processing device according to claim 1, wherein
the transparency control data includes a plurality of dot data pieces corresponding to respective dots in the screen,
each of the dot data pieces corresponding to respective dots included in the designated region is video data indicating a predetermined designated color, and each of the dot data pieces corresponding to respective dots included in a region other than the designated region is video data indicating a color other than the designated color,
the synthesis processing unit includes:
a transparency region adding unit that replaces the dot data pieces included in a region indicating the designated color with the second video signal in the transparency control data to generate a transparency region adding video signal in which a region indicating the color other than the designated color is added to the second video signal as a transparency region;
a designated color transparency control unit that receives the transparency region adding video signal and generates a selection signal to select the first video signal in a section indicating the designated color in the transparency region adding video signal and select the transparency region adding video signal in a section indicating the color other than the designated color in the transparency region adding video signal; and,
a selector that selects one of the first video signal and the transparency region adding video signal according to the selection signal, and outputs the selected signal as the synthetic video signal.

7. The video processing device according to claim 1, wherein
the memory is a non-volatile memory in which the transparency control data is rewritable.

8. The video processing device according to claim 7, comprising
a substrate provided with the synthesis processing unit and a connector that removably connects the memory.

9. A video processing system comprising:
a first camera that outputs a first video signal indicating a recorded video;
a second camera that outputs a second video signal indicating a recorded video;
a display device with a single screen;
a synthesis processing unit that generates a synthetic video signal by rendering a first video included in a designated region in the screen transparent and synthesizing the first video and a second video in a manner in which the first video based on the first video signal is arranged in the screen and the second video based on the second video signal different from the first video signal is arranged in the screen;
a memory that stores transparency control data for specifying the designated region and indicating a transparency aspect of the first video in the designated region; and
a data change control unit that overwrites the transparency control data stored in the memory with transparency control data for rewrite when the data change control unit receives the transparency control data for rewrite and a data change command.

10. The video processing system according to claim 9, wherein
the synthesis processing unit arranges the second video to be superimposed on at least a part of the first video, and the designated region in the screen is in a region in which the first video and the second video are superimposed.

11. The video processing system according to claim 9, wherein
the transparency control data includes a plurality of dot data pieces corresponding to respective dots in the screen, and
each of the dot data pieces corresponding to respective dots included in the designated region indicates a transmittance of 100%, and each of the dot data pieces corresponding to respective dots included in a region other than the designated region indicates the transmittance of 0%.

12. The video processing system according to claim 9, wherein
the transparency control data includes a plurality of dot data pieces corresponding to respective dots in the screen, and
each of the dot data pieces corresponding to respective dots included in a boundary between the designated region and a region other than the designated region in the screen indicates a transmittance of 50%, each of the dot data pieces corresponding to respective dots excluding the dots included in the boundary among the dots included in the designated region indicates the transmittance of 100%, and each of the dot data pieces corresponding to respective dots included in the region other than the designated region indicates the transmittance of 0%.

13. The video processing system according to claim 9, wherein
the transparency control data includes a plurality of dot data pieces corresponding to respective dots in the screen,
each of the dot data pieces corresponding to respective dots included in the designated region is video data indicating a predetermined designated color, and each of the dot data pieces corresponding to respective dots included in a region other than the designated region is video data indicating a color other than the designated color,
the synthesis processing unit includes:
a transparency region adding unit that replaces the dot data pieces included in a region indicating the designated color with the second video signal in the transparency control data to generate a transparency region adding video signal in which a region indicating the color other than the designated color is added to the second video signal as a transparency region;
a designated color transparency control unit that receives the transparency region adding video signal and generates a selection signal to select the first video signal in a section indicating the designated color in the transparency region adding video signal and select the transparency region adding video signal in a section indicating the color other than the designated color in the transparency region adding video signal; and,
a selector that selects one of the first video signal and the transparency region adding video signal according to the selection signal, and outputs the selected signal as the synthetic video signal.

14. The video processing system according to claim 9, wherein
the memory is a non-volatile memory in which the transparency control data is rewritable.

15. The video processing system according to claim 14, comprising
a substrate provided with the synthesis processing unit and a connector that removably connects the memory.
